(19) United States
(12) Patent Application Publication
(10) Pub. No.: US 2006/0148978 A1
(43) Pub. Date: Jul. 6, 2006

(54) Polymer structures formed on fibers and/or nanofiber

(76) Inventors: Darrell H. Reneker, Akron, OH (US); George C. Chase, Wadsworth, OH (US); Daniel J. Smith, Stow, OH (US); Sphurti Doiphode, Akron, OH (US)

Correspondence Address: ROETZEL AND ANDRESS, 222 SOUTH MAIN STREET, AKRON, OH, 44308, US

(21) Appl. No.: 11/237,154

(22) Filed: Sep. 28, 2005

Related U.S. Application Data
(60) Provisional application No. 60/613,657, filed on Sep. 28, 2004.

(51) Int. Cl. C08L 31/00

(52) U.S. Cl. 524/556

(57) ABSTRACT

In one embodiment, the present invention relates to a method for producing polymer nanostructures, the method comprising the steps of: forming at least one nanostructure substrate, web, membrane or mat; exposing the at least one nanostructure substrate, web, membrane or mat to at least one monomer composition, where the at least one monomer composition is in a vapor phase and the at least one monomer composition is deposited on the surface of and/or within the at least one nanostructure substrate, web, membrane or mat; and subjecting the at least one exposed nanostructure substrate, web, membrane or mat to conditions suitable to polymerize the at least one monomer composition, thereby yielding polymer nanostructures where the polymer nanostructures are formed on and/or in the nanostructure substrate, web, membrane or mat.

### RELATED APPLICATION DATA

This application claims priority to previously filed U.S. Provisional Application No. 60/613,657 filed on Sep. 28, 2004, entitled “Synthesis of Thermoplastic Polyurethane Nanocompsites”, and is hereby incorporated by reference in its entirety.

### FIELD OF THE INVENTION

The present invention relates to cyanoacrylate polymers and their use in conjunction with fibers and/or nanofibers, and to processes for forming cyanoacrylate coated polymer fibers and/or nanofibers. Furthermore, the present invention relates to the use of cyanoacrylate polymers as an adhesive, bonding agent or agglomeration agent in order to bind or agglomerate fibers and/or nanofibers to each other, and to processes for producing bound and/or agglomerated polymer structures. In still another embodiment, the present invention relates to the use of cyanoacrylate polymers to form sphere-like structures made from various polymer fibers/nanofibers, and to methods for making such structures.

### BACKGROUND OF THE INVENTION

Nanofiber technology has just begun to develop and therefore engineers and entrepreneurs have not had a reliable source of nanofiber, or coated nanofibers, to incorporate into their designs. Uses for nanofibers, and in particularly coated-nanofibers, will grow with improved prospects for cost-efficient manufacturing. Accordingly, the development of significant markets for nanofibers is almost certain in the next few years. The introduction of nanofibers into useful products are already underway in the high performance filter industry.

In light of the above, the ability to produce coated polymer fibers and/or nanofibers is highly desirable. One useful coating material is cyanoacrylate, popularly known as Super Glue. Cyanoacrylates have various applications other than being used as a household adhesive. For example, cyanoacrylate can be used in targeted drug delivery and for the closing of surgical wounds. Accordingly, there is a need in the art for polymer coated fibers/nanofibers and methods to produce the same. There is also a need in the art for a method designed to permit the connection, bonding and/or agglomeration of fibers/nanofibers using a suitable polymer coating.

### SUMMARY OF THE INVENTION

The present invention relates to cyanoacrylate polymers and their use in conjunction with fibers and/or nanofibers, and to processes for forming cyanoacrylate coated polymer fibers and/or nanofibers. Furthermore, the present invention relates to the use of cyanoacrylate polymers as an adhesive, bonding agent or agglomeration agent in order to bind or agglomerate fibers and/or nanofibers to each other, and to processes for producing bound and/or agglomerated polymer structures. In still another embodiment, the present invention relates to the use of cyanoacrylate polymers to form sphere-like structures made from various polymer fibers/nanofibers, and to methods for making such structures.

In one embodiment, the present invention relates to a method for producing polymer nanostructures, the method comprising the steps of: forming at least one nanostructure substrate, web, membrane or mat; exposing the at least one nanostructure substrate, web, membrane or mat to at least one monomer composition, where the at least one monomer composition is in a vapor phase and the at least one monomer composition is deposited on the surface of and/or within the at least one nanostructure substrate, web, membrane or mat; and subjecting the at least one exposed nanostructure substrate, web, membrane or mat to conditions suitable to polymerize the at least one monomer composition, thereby yielding polymer nanostructures where the polymer nanostructures are formed on and/or in the nanostructure substrate, web, membrane or mat.

In another embodiment, the present invention relates to a polymer nanostructure comprising: at least one nanostructure substrate, web, membrane or mat; and at least one polymer nanostructure formed on and/or in the at least one nanostructure substrate, web, membrane or mat.

### BRIEF DESCRIPTION OF THE DRAWINGS

FIG. 1 is an illustration depicting one possible method of cyanoacrylate fiber/particle formation on a fiber/nanofiber substrate;

FIG. 2 is an illustration depicting one possible setup for depositing and/or forming cyanoacrylate coated and/or modified fibers/nanofibers according to the present invention;

FIG. 3(A) is an illustration depicting another possible setup for depositing and/or forming cyanoacrylate coated and/or modified fibers/nanofibers according to the present invention;

FIG. 3(B) is a close up of washer structure 50a of FIG. 3(A);

FIG. 4 is a scanning electron microscope (SEM) photograph of Nomex® fibers used as a substrate in the present invention;

FIGS. 5(A) through 5(F) are SEM photographs of: cyanoacrylate polymer beads (FIGS. 5(A) through 5(D)) formed on the Nomex® fibers of FIG. 4 using the setup of FIG. 3(A); and cyanoacrylate polymer fibers (FIGS. 5(D) and 5(E)) formed on the Nomexe fibers of FIG. 4 using the setup of FIG. 3(A);

FIGS. 6(A) through 6(F) are SEM photographs of: cyanoacrylate polymer beads (FIGS. 6(C) and 6(E)) formed on the Nomexe fibers of FIG. 4 using the setup of FIG. 3(A); and cyanoacrylate polymer fibers (FIGS. 6(A), 6(B), 6(D) and 6(F)) formed on the Nomex® fibers of FIG. 4 using the setup of FIG. 3(A);

FIG. 7(A) is an alternative embodiment of the washer of FIG. 3(B) where the washer structure has a microfiber cross formed thereon;

FIGS. 7(B) through 7(E) are SEM photographs of cyanoacrylate polymer fibers formed on the Nomex® fibers of FIG. 4 using the setup of FIG. 3(A) with the washer structure of FIG. 7(A);

FIGS. 8(A) through 8(D) are SEM photographs of: cyanoacrylate polymer fibers formed on the Nomex® fibers (FIGS. 8(A) and 8(B)) of FIG. 4 using the setup of FIG. 3(A); cyanoacrylate polymer fibers formed on a glass substrate using the setup of FIG. 3(A) (FIG. 8(C)); and cyanoacrylate polymer beads formed on a glass substrate using the setup of FIG. 3(A) (FIG. 8(D)); and

FIGS. 9(A) through 9(D) are tunneling electron microscope (TEM) photographs of cyanoacrylate polymer fibers formed on the Nomexe fibers of FIG. 4 using the setup of FIG. 3(A).

### DETAILED DESCRIPTION OF THE INVENTION

The present invention relates to cyanoacrylate polymers and their use in conjunction with fibers and/or nanofibers, and to processes for forming cyanoacrylate coated polymer fibers and/or nanofibers. Furthermore, the present invention relates to the use of cyanoacrylate polymers as an adhesive, bonding agent or agglomeration agent in order to bind or agglomerate fibers and/or nanofibers to each other, and to processes for producing bound and/or agglomerated polymer structures. In still another embodiment, the present invention relates to the use of cyanoacrylate polymers to form sphere-like structures made from various polymer fibers/nanofibers, and to methods for making such structures.

As used herein nanofibers are fibers having an average diameter in the range of about 1 nanometer to about 25,000 nanometers (25 microns). In another embodiment, the nanofibers of the present invention are fibers having an average diameter in the range of about 1 nanometer to about 10,000 nanometers, or about 1 nanometer to about 5,000 nanometers, or about 3 nanometers to about 3,000 nanometers, or about 7 nanometers to about 1,000 nanometers, or even about 10 nanometers to about 500 nanometers. In another embodiment, the nanofibers of the present invention are fibers having an average diameter of less than 25,000 nanometers, or less than 10,000 nanometers, or even less than 5,000 nanometers. In still another embodiment, the nanofibers of the present invention are fibers having an average diameter of less than 3,000 nanometers, or less than about 1,000 nanometers, or even less than about 500 nanometers. Additionally, it should be noted that here, as well as elsewhere in the text, ranges may be combined.

The length of the nanofibers used in the present invention is not critical and any length nanofiber can be used in the present invention. In one embodiment, the nanofibers used in the present invention are at least about 0.5 meters in length, or at least about 1 meter in length, or at least about 5 meters in length, or at least about 10 meters in length, or at least about 25 meters in length, or at least about 50 meters in length, or at least about 100 meters in length, or at least about 250 meters in length, or at least about 500 meters in length, or at least about 1 kilometer in length, or at least about 3 kilometers in length, or at least about 5 kilometer in length, or even at least about 10 kilometer in length.

The fibers/nanofibers of the present invention can be fabricated according to a variety of methods known in the art including, but not limited to, electrospinning, wet spinning, dry spinning, melt spinning, and gel spinning. Electrospinning is particularly suitable for fabricating fibers of the present invention inasmuch as it tends to produce the thinnest (i.e., finest denier) fibers of any of the foregoing methods. Typically electrospun fibers can be produced having very small diameters, usually on the order of about 3 nanometers to about 3000 nanometers. In another embodiment, electrospun fibers can be produced on order of about 10 nanometers to about 500 nanometers, or even on the order of about 10 nanometers to about 100 nanometers.

Another particularly effective method for producing nanofibers of the present invention comprises the nanofibers by gas jet method (i.e., NGJ method). This method has been previously described and is known in the art. Briefly, the method comprises using a device having an inner tube and a coaxial outer tube with a sidearm. The inner tube is recessed from the edge of the outer tube thus creating a thin film-forming region. Polymer melt is fed in through the sidearm and fills the empty space between the inner tube and the outer tube. The polymer melt continues to flow toward the effluent end of the inner tube until it contacts the effluent gas jet. The gas jet impinging on the melt surface creates a thin film of polymer melt, which travels to the effluent end of tube where it is ejected forming a turbulent cloud of nanofibers.

Electrospinning and NGJ techniques permit the processing of polymers from both organic and aqueous solvents. Exemplary patents that disclose NGJ methods include U.S. Pat. Nos. 6,695,992; 6,520,425; and 6,382,526, all of which are incorporated by reference in their entireties. A suitable electrospinning process for producing nanofibers/fibers is disclosed in, for example, U.S. Pat. No. 6,753,454, which is hereby incorporated by reference for its teachings related to electrospinning of fibers/nanofibers.

Furthermore, it has been discovered that dispersions of discrete particles and soluble non-fiber forming additives into the fluid to be spun into the fiber (i.e., the spin dope) does not prevent the formation of membranes using electrospinning and NGJ techniques. Therefore, a wide variety of additives may be incorporated into fibers and devices of the present invention.

As is noted above, the present invention relates to cyanoacrylate polymers and their use in conjunction with fibers and/or nanofibers, and to processes for forming cyanoacrylate coated polymer fibers and/or nanofibers. In another embodiment, the present invention is directed to the use of cyanoacrylate polymers on fibers/nanofibers to stick, connect and/or agglomerate the fibers/nanofibers to one another.

The invention utilizes a cyanoacrylate fuming method (see Advances in Fingerprint Technology, Dr. Henry Lee and Dr. R. E. Gaensslen, Elsevier, New York, 1991) to form a polymer structure, coating and/or particles of cyanoacrylate polymer on or embedded in fibers/nanofibers produced via one or more of the above-mentioned techniques.

In one embodiment, a fiber or nanofiber web, mat or membrane is formed via any suitable technique (e.g., an electrospinning or NGJ technique). The fiber/nanofiber web, mat or membrane is then exposed to a cyanoacrylate monomer vapor, whereupon the monomer vapor is captured by the web, mat or membrane as it pass through the web, mat or membrane. Due to the presence of water molecules in the atmosphere surrounding the web, mat or membrane, the cyanoacrylate monomer undergoes polymerization (e.g., anionic polymerization) thereby coating and/or depositing cyanoacrylate polymer upon or within the fibers/nanofibers that make up the web, mat or membrane. In another embodiment, the water needed to initiate the polymerization of the cyanoacrylate monomer is present within the fiber or nanofiber web, mat or membrane. In still another embodiment, water is present in both the surrounding atmosphere and within the fiber/nanofiber web, mat or membrane to be coated and/or subjected to polymer deposition.

As is noted above, the polymerization reaction that polymerizes the cyanoacrylate monomer is initiated by the water. Depending on the temperature at which the monomer liquid is heated, different types of polycyanoacrylate structures *(e.g., fibers, spheres, etc.) are formed on the fibers/nanofibers.

In one embodiment, polycyanoacrylate fibers are formed in and/or on the fibers of the above-mentioned web, mat or membrane. In one instance, the network of polycyanoacrylate fibers formed on a web, mat or membrane of electrospun fibers can be used as a filter media. The strength of the web, mat or membrane increases due to the presence of polycyanoacrylate fibers. If so desired, the fibers/nanofibers of the web, mat or membrane upon which the polycyanoacrylate fibers are formed can be removed using any suitable method. This yields a structure that contains primarily polycyanoacrylate fibers. Such removal techniques are known to those of ordinary skill in the art, and depend primarily upon what type of fibers/nanofibers are used to form the web, mat or membrane upon which the aforementioned polycyanoacrylate fibers are deposited. It should be noted, that the removal of the underlying polymer fibers/nanofibers is not limited to just the embodiment where polycyanoacrylate fibers are formed on a web, mat or membrane. Rather, the underlying web, mat or membrane can be removed regardless of the geometrical shape of the polycyanoacrylate structures.

The cyanoacrylate monomer used in the present invention can be selected so that the polycyanoacrylate polymer formed therefrom is biodegradable and/or bioabsorbable. This feature can be important if the product or products produced by the present invention are destined for use as drug-delivery devices. As is known to those of ordinary skill in the art, the degradation rate of a polycyanoacrylate polymer depends, in part, on the length of the alkyl chain with, for example, hexadecyl degrading slower compared to isohexyl and isobutyl.

In one embodiment, the polycyanoacrylate polymer of the present invention is in the form of nanospheres that can, if so desired, be coated with polyethylene glycol. These nanospheres can be to be used for targeted drug-delivery. It should be noted that the surface modification of the polycyanoacrylate polymer particles with a polyethylene glycol coating has very little to no effect on the degradation rate of the polycyanoacrylate polymer nanospheres. The common techniques of preparing polycyanoacrylate nanoparticles are by dispersion and emulsion polymerization of cyanoacrylate monomer (see Lherm et al., Int. J. Pharm., 1992, Vol. 84, pp.13-22).

As used herein nanospheres are spherical particles having an average diameter in the range of about 1 nanometer to about 25,000 nanometers (25 microns). In another embodiment, the nanospheres of the present invention are spherical particles having an average diameter in the range of about 1 nanometer to about 10,000 nanometers, or about 1 nanometer to about 5,000 nanometers, or about 3 nanometers to about 3,000 nanometers, or about 7 nanometers to about 1,000 nanometers, or even about 10 nanometers to about 500 nanometers. In another embodiment, the nanospheres of the present invention are spherical particles having an average diameter of less than 25,000 nanometers, or less than 10,000 nanometers, or even less than 5,000 nanometers. In still another embodiment, the nanospheres of the present invention are spherical particles having an average diameter of less than 3,000 nanometers, or less than about 1,000 nanometers, or less than about 600 nanometers, or even less than about 300 nanometers. It should be noted that the nanoparticles do not have to be perfectly spherical in shape. Rather, substantially spherical particles such as tear-drop shaped particles, dumbbell-shaped particles, and/or elliptical or ellipsoidal particles can be used so long as the average diameter of the particle is no greater than the numerical values stated above. U.S. Pat. No. 6,120,806 discloses various types of microspheres (nanospheres) that can be used for drug delivery, and is hereby incorporate by reference for its teachings as to microspheres.

In one embodiment, the cyanoacrylate monomer used in the present invention is a low viscosity, colorless liquid monomer. Although not solely limited thereto, exemplary cyanoacrylates are alkyl esters of 2-cyanoacrylic acid including methyl, ethyl, n-propyl, allyl, n-butyl, isobutyl, 2-mthoxyethyl, 2-methoxypropyl and n-octyl derivatives. Ethyl cyanoacrylates are readily available as adhesives and can be used in the present invention. In one embodiment, the cyanoacrylate adhesive comprises of monomer, at least one stabilizer (e.g., hydroquinone) and optionally, one or more additives (e.g., a thickeners such as polymethylmethacrylate).

Cyanoacrylate polymers are colorless and amorphous solids. The polymer is soluble in polar aprotic solvents (DMF, DMSO) and insoluble in both non-polar solvents (hexane, ether) and polar solvents (methanol, water). Solubility improves as the size of the alkyl group increases. For example, ethyl cyanoacrylate in its cured state has dielectric constant value of 3.98, and the polymer melts at 185° C. and has a T_{g} of 172° C.

Contact angle with water for poly(methylcyanoacrylate), poly(ethylcyanoacrylate), poly(butylcyanoacrylate) are 57°, 65°, 69°, respectively, compared to Teflon at 110°.

Chemistry of Cyanoacrylate Polymerization:

In the case of cyanoacrylate molecule the —CH₂ group is highly electropositive as a result of electron-withdrawing properties of the cyanide and ester groups. Therefore, the monomer is highly polar. Weak initiators like water or alkoxides, can initiate cyanoacrylate polymerization. The free energy of the initiation step is favorable for the cyanoacrylate monomer as the propagating carbanion is strongly stabilized due to resonance. Electron withdrawing groups or groups with double bonds present lead to stabilization by resonance. If the anionic reaction is carried out carefully then termination reactions do not occur in anionic polymerization. Compounds such as water and/or alcohol need to be deliberately added to terminate the polymerization reaction.

The new anionic species formed are too weak to reinitiate. Also compounds like water, alcohols, molecular oxygen, carbon dioxide etc. can react with the propagating carbanions thereby quickly terminating the propagation. The system needs to be thoroughly dried and de-aerated to yield a suitable polymerization system.

Initiation Step:

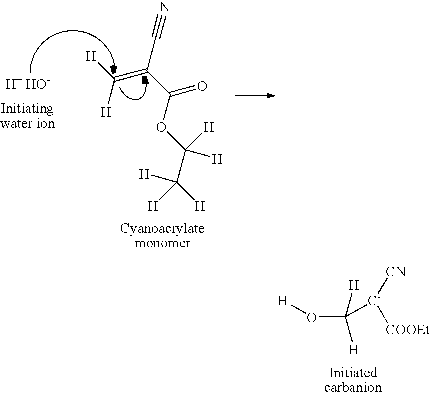

Propagation Step:

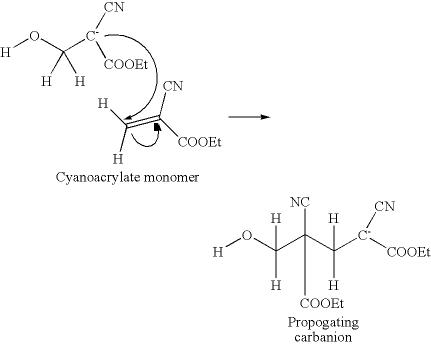

Termination Step:

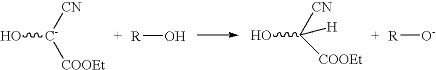

The beauty of anionic polymerization systems lies in diversity of organic chemistry possible with carbanions. The anionic polymerization can be terminated with different molecules to get end-functionalized polymers. Also if the chain remains active after all the monomer is consumed and another monomer is introduced in the system then block copolymers are possible.

Carboxylation of Propagating Carbanion:

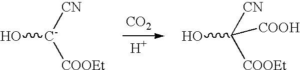

Reaction Scheme for Placing an Alcohol Group at the End of Propagating Carbanion:

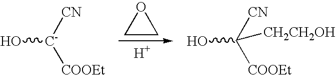

Block Copolymer Formation Scheme:

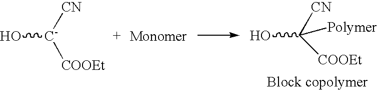

Some important aspects of anionic polymerization are all that chains are initiated at once (fast initiation), the polymer chains all grow under identical conditions, little or no termination takes place (except deliberately), and no de-polymerization occurs.

Chemistry of Anionic Polymerization: 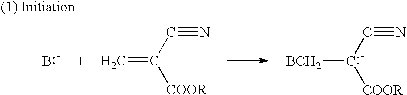 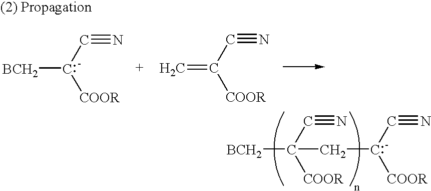
where n is an integer in the range of 2 to about 25,000, or from about 5 to about 20,000, or from about 10 to about 15,000, or from about 15 to about 10,000, or from about 20 to about 5,000, or even from about 25 to about 1,000, and where R is either an alky group having from 1 to about 30 carbon atoms, or from about 2 to about 20 carbon atoms, or from about 3 to about 10 carbon atoms, or even from about 4 to about 8 carbon atoms or a cyclic group containing 3 to about 12 carbon atoms, or 4 to about 10 carbon atoms, or even from about 5 to about 8 carbon atoms.

In another embodiment, n is an integer in the range of 2 to about 1,000, or from about 5 to about 500, or from about 10 to about 300, or from about 15 to about 200, or from about 20 to about 100, or even from about 25 to about 75.

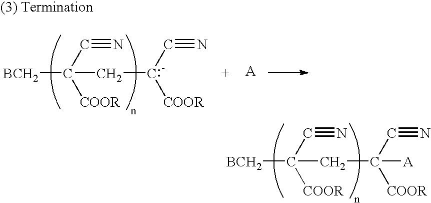

It should be noted that the present invention is not limited solely to the reaction scheme shown in reactions (1) to (3) above. Rather, any suitable monomer can be used as is described herein.

A specific reaction scheme for the initiation and propagation steps is shown below:

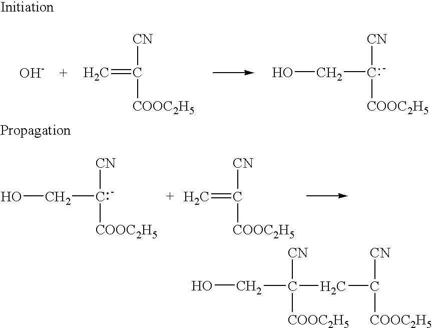

As would be apparent to those of ordinary skill in the art, the free energy of initiation step must be favorable for the initiation step to be feasible. In case of cyanoacrylate monomer the propagating anion is strongly stabilized due to resonance (as is noted above). Also as discussed above, electron withdrawing groups or groups with double bonds present leads into stabilization by resonance. Accordingly, weak initiators like water, alkoxides, can initiate cyanoacrylate polymerization.

The —CH₂ group is highly electropositive as a result of electron-withdrawing properties of the cyanide and ester groups; therefore the electron pair is attracted to this region. Again, the beauty of anionic polymerization lies in diversity of organic chemistry possible with carbanion. The chain ends can be functionalized as follows:

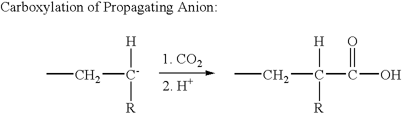

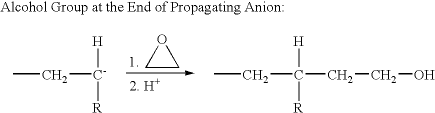

The following exemplary undesirable side reactions are possible:

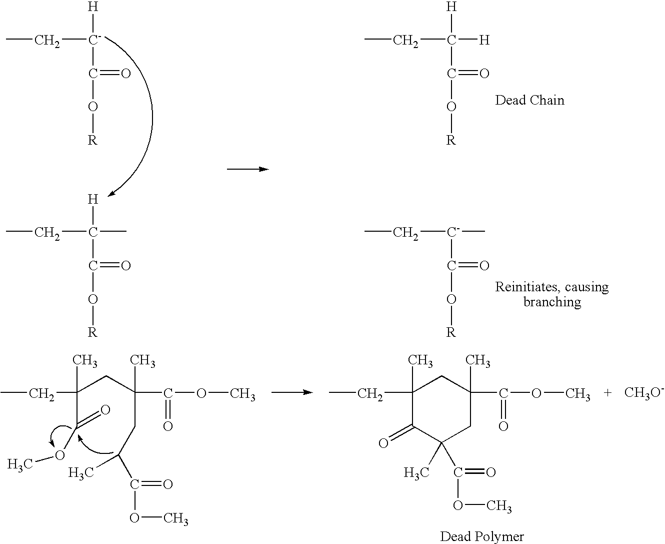

The most common undesirable reaction is the reaction where an ester group is cleaved and the above ring structure is formed. This is because the transition state is a six-membered ring and is entropically favorable. The reaction causes a cyclization, and ejects an alkoxide as a leaving group. Since the alkoxide is too weak a nucleophile to reinitiate, this process ends in a termination. The reaction can also occur further back in the same chain, or in the middle of a separate chain, but the chemistry depicted above predominates.

If polymerized anionically and allowed to stand, the end groups of PMMA are contained in the ring structure detailed above. However, since the activation energy of cyclization is greater than that of propagation, the former is affected more by temperature than the latter. Therefore, by running the reaction at low temperatures, the undesired cyclization reaction is suppressed, and propagation occurs without the unwanted reactions detailed above. It should be noted that the low reaction temperature decreases the rate of both the cyclization and propagation reactions, but the rate of cyclization reaction is more sensitive to the low temperature and thus decreases more.

If the chain ends are still active when the monomer is consumed, it is possible to add more monomer and continue the reaction. In one embodiment, the additional monomer added is identical to the initial monomer used. In another embodiment, the additional monomer differs from the monomer initially used in the polymerization reaction. As would be apparent to those of ordinary skill in the art, the use of two different monomer compounds will yield a copolymer product (e.g., a block copolymer) as switching over to another monomer leads to propagation/formation of a new polymer chain covalently bound to the previous one. The example below details a block copolymer: 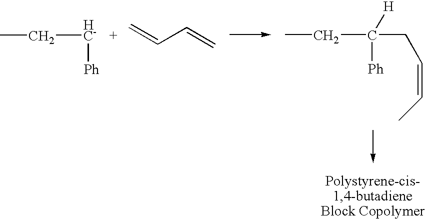
Some of the important attribute of the polymerization scheme of the present invention are that: (1) all the polymer chains are initiated at once or nearly at one (fast initiation); (2) there is little or no unwanted termination that occurs; (3) there is little or no de-polymerization; and (4) all the polymer chains grow under identical or nearly identical conditions.

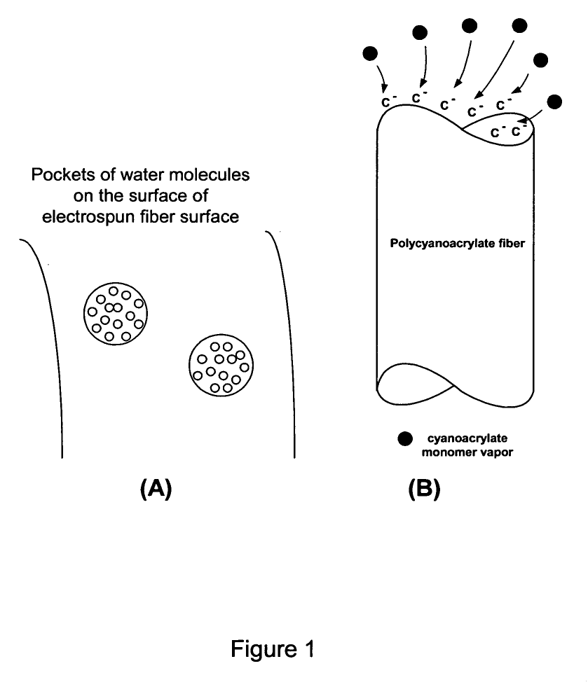

In one embodiment, the water molecules necessary to initiate the above-mentioned polymerization reaction are present as water molecule pockets on the surface of the fibers/nanofibers to be coated (e.g., electrospun fibers and/or nanofibers). This embodiment is illustrated in FIGS. 1(A) and 1(B). As can be seen from FIGS. 1(A) and 1(B), when water molecules come in contact with one or more cyanoacrylate monomer molecules, polymerization is initiated as detailed above. The fast reaction rate of the polymerization reaction of the present invention leads to, in one embodiment, the formation of fiber-like structures composed of polycyanoacrylate (see the accompanying photographs) via the carbanion method discussed above, until all of the cyanoacrylate monomer is consumed. Once all the monomer is consumed, termination is deliberately accomplished by adding water in the form of steam or vapor. A unique structure of polycyanoacrylate nanofibers on the electrospun nanofibers is obtained via one of the processes of the present invention.

In another embodiment, polymer beads can be formed using a higher vapor pressure of cyanoacrylate monomer. This is because the increased vapor pressure of the cyanoacrylate monomer leads to the formation of monomer droplets, which in turn are captured by the fiber and/or nanofiber web, mat or membrane upon which the polycyanoacrylate forms. The formation of beads occurs by a vapor deposition diffusion mechanism. The added water initiates and terminates the reaction giving spherical polycyanoacrylate polymer on, for example, an electrospun fibers web, mat or membrane.

### EXAMPLES

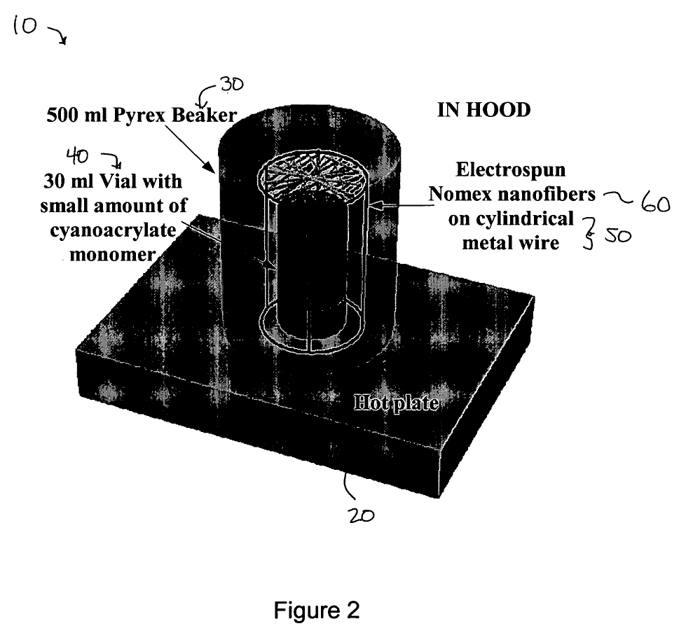

Poly(meta-phenylene isophthalamide) (MPD-I) (Nomex®) nanofibers are prepared by electrospinning a solution of the polymer. The Nomex® solution is obtained by dissolving Nomex® fibers (Mw=90,000 g/mole, Dupont) in N,N-dimethylacetamide containing 4% lithium chloride at 60° C. to form a homogeneous solution with 16 weight percent polymer concentration. During electrospinning, the polymer solution is held in a glass pipette. When a high voltage is applied through a copper wire in electrical contact with the solution, a charged liquid jet emerges from a liquid drop at the tip of the pipette. As the jet travels in air, the solvent evaporates, leaving behind charged polymer fibers 60, which are collected on cylindrically shaped thin metal wire structure 50 (see FIG. 2). Once the formation of the electrospun fibers 60 is complete the cylindrical metal wire structure 50 is further used as explained below.

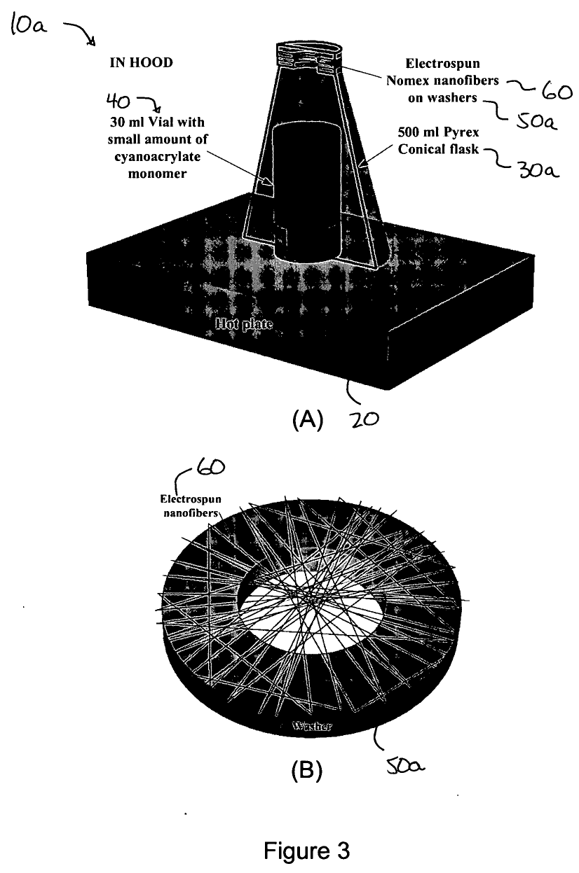

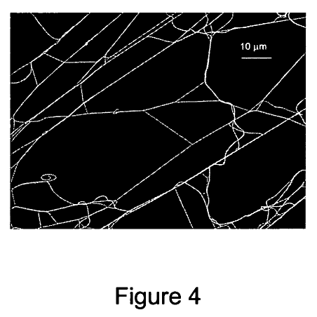

In another embodiment, the cylindrical metal wire structure 50 can be replace with a washer-like structure 50a (see FIGS. 3(A) and 3(B)). Continuous fibers of average diameter 333 nm are collected as a thin non-woven fiber network. A scanning electron microscope (SEM) photograph of such fibers is shown in FIG. 4. The spinning voltage is in the range of 15 to 25 kV, which produces an electric field of about 1 kV/m.

Once the formation of the electrospun fibers 60 is complete the cylindrical metal wire structure 50 and/or the washer structure 50a these structures and the nanofibers contained thereon are respectively placed into cyanoacrylate deposition setups 10 and 10a, as discussed below.

Although two methods for producing electrospun fibers have been discussed, the present invention is not limited thereto. Rather, any suitable technique can be used to produce fiber and/or nanofiber structures for use in the present invention. Accordingly, the present invention is not limited solely to the production of nanofibers via an electrospinning technique.

Turning to FIG. 2, cyanoacrylate deposition setup 10 comprises a hot plate 20 with a suitably size inverted Pyrex beaker 30 thereon. The Pyrex beaker 30 contains therein a vial 40 with a sufficient amount of cyanoacrylate monomer as the precursor material for the polycyanoacrylate fibers, particles and/or coating that are to be formed on, in and/or around the previously formed nanofibers 60. As discussed above, any number of polycyanoacrylate structures can be formed on the nanofibers 60, or within the nanofiber network. The present example is directed towards the formation of polycyanoacrylate fibers, but the present invention is not limited thereto.

In setup 10 of FIG. 2, a small amount of cyanoacrylate monomer liquid is placed in a open 30 ml vial on hot plate 20. Then the cylindrical metal wire structure 50 with electrospun fibers 60 is placed on the top of vial 40 as shown in FIG. 2. Next, an inverted beaker 30 is placed as shown. The vapors of monomer created are captured by nanofibers and monomer droplets form on nanofibers 60. Next, the humidity is increased by placing a sufficient amount of water on the surface of hot plate 20 located under beaker 30. As discussed above, the water initiates the polymerization of the cyanoacrylate monomer present on and/or in the network of nanofibers 60, thereby yielding polymer fibers or beads depending upon the temperature of the hot plate 20 during the polymerization step. The structure and size of the polycyanoacrylate fibers and/or beads are shown in the photographs of FIGS. 4 through 9 and are discussed in detail below.

Turning to FIG. 3(A), this setup 10a is used to determine if the cyanoacrylate monomer vapor passes through the nanofiber membrane. The experiment is done in a conical flask 30a as shown in FIG. 3(A). Nanofibers 60 are formed/collected on washer structure 50a as described above. In the case of setup 10a, three washer structures 50a all with nanofibers 60 thereon are stacked on top of one another on the top of flask 30a. Flask 30a is capped with a glass cover plate to prevent the escape of the cyanoacrylate monomer vapor. The method then proceeds as explained above with regard to FIG. 2.

After completion of the polymerization step, each of the washer structures 50a are observed and the presence of cyanoacrylate polymer is confirmed on each of the nanofiber networks. Thus, the monomer vapor does pass through each individual nanofiber network, although the amount of polymer formed on each layer decreases with increasing height from the top of flask 30a. Scanning electron microscope photographs of the polycyanoacrylate structures formed via the methods of the present invention confirmed that different temperatures yield different structures (e.g., fibers or beads). Also, the distance of the mouth of vial 40 from nanofibers 60 influences the type or types of polycyanoacrylate structures formed on or in nanofibers 60.

In order to ensure no contamination, prior to each experiment beaker 30 and/or conical flask 30a are cleaned with acetone, followed by a water rinse and then placed in oven at 100° C. to remove any moisture and polymer present on/in the beaker or flask.

Strength measurements are done on polycyanoacrylate nanofiber washer structure by passing air at a constant pressure through the polymer structure formed on washer 50a. An untreated nanofiber network of electrospun nanofibers breaks at around 15 psi. While a cyanoacrylate treated nanofiber network of electrospun nanofibers breaks 40-50 psi. Note that during these experiments the washer size is kept the same and the nanofiber networks are produced under the same set of electrospinning conditions.

It should be noted that the present invention does not always require an external humidity source (i.e., the addition of liquid water to the hot plate as described above). Rather, in one embodiment no external humidity is required for initiation of the cyanoacrylate polymerization as the process uses the humidity already present in the system for fiber/bead formation.

In another embodiment, water is deliberately added into the system before exposing the fibers to cyanoacrylate monomer deposition. The addition of water causes the number of fibers formed per unit length of electrospun nanofiber to increase. Control of the amount of water added permits the control the number/frequency of initiation sites. Accordingly, the number of cyanoacrylate fibers/beads/spheres increases as more condensed droplets of water are present on the nanofiber substrate. Also less branching is observed as the amount of water present increases since all the monomer is consumed between the initiation sites.

Furthermore, as the source temperature from which the monomer vapor is generated increases the density of fibers and/or beads formed increases. In one embodiment, the polycyanoacrylate structures formed change from fibers to beads/spheres at a source temperature of about 240° C. to about 290° C., or from about 245° C. to about 285° C., or from about 250° C. to about 280° C., or from about 255° C. to about 275° C., or from about 260° C. to about 270° C., or even at a source temperature of about 265° C. Although a hot plate is used as a heat source for the present invention (i.e., for warming the cyanoacrylate monomer solution), the present invention is not limited thereto. Rather, any other method of heat is acceptable as long as cyanoacrylate monomer is not exposed to a temperature greater than its decomposition temperature (about 320° C.). Further, it is not advisable to inhale polycyanoacrylate vapors, therefore all these experiments are done in hood to avoid vapor inhalation.

Via the method of the present invention, fibers and/or spheres of polycyanoacrylate can be obtained by using, for example, an electrospun membrane substrate that is later removed using a solvent, or via heating, degradation and/or radiation.

In another embodiment, since polycyanoacrylate fibers, beads or spheres are formed by anionic polymerization, they can be functionalized or surface functionalized.

Photograph Discussion:

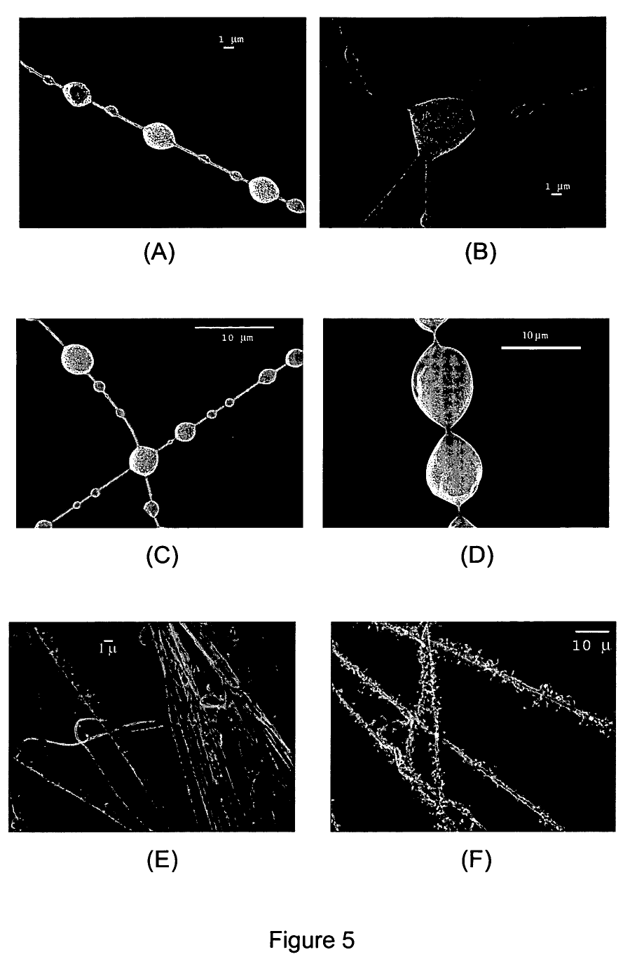

Turning to FIGS. 5(A) through 5(F), FIGS. 5(A) through 5(F) are SEM photographs of: cyanoacrylate polymer beads (FIGS. 5(A) through 5(D)) formed on the Nomex® fibers of FIG. 4 using the setup of FIG. 3(A); and cyanoacrylate polymer fibers (FIGS. 5(D) and 5(E)) formed on the Nomex® fibers of FIG. 4 using the setup of FIG. 3(A). Each Figure will be discussed in more detail below.

As can be seen from FIGS. 5(A) through 5(D), polycyanoacrylate beads are formed on nanofibers 60 of washer 50a. These beads are formed using a source temperature of 290° C. in conjunction with the setup shown in FIG. 3(A).

FIG. 5(D) is a SEM photograph of polycyanoacrylate fibers that are formed on nanofibers 60 of washer 50a at a source temperature of 150° C. for 1 hour using 50 milligrams of monomer starting material in the setup of FIG. 3(A).

FIG. 5(E) is a SEM photograph of polycyanoacrylate fibers that are formed on nanofibers 60 of washer 50a at a source temperature of 200° C. for 1 hour using 50 milligrams of monomer starting material in the setup of FIG. 3(A).

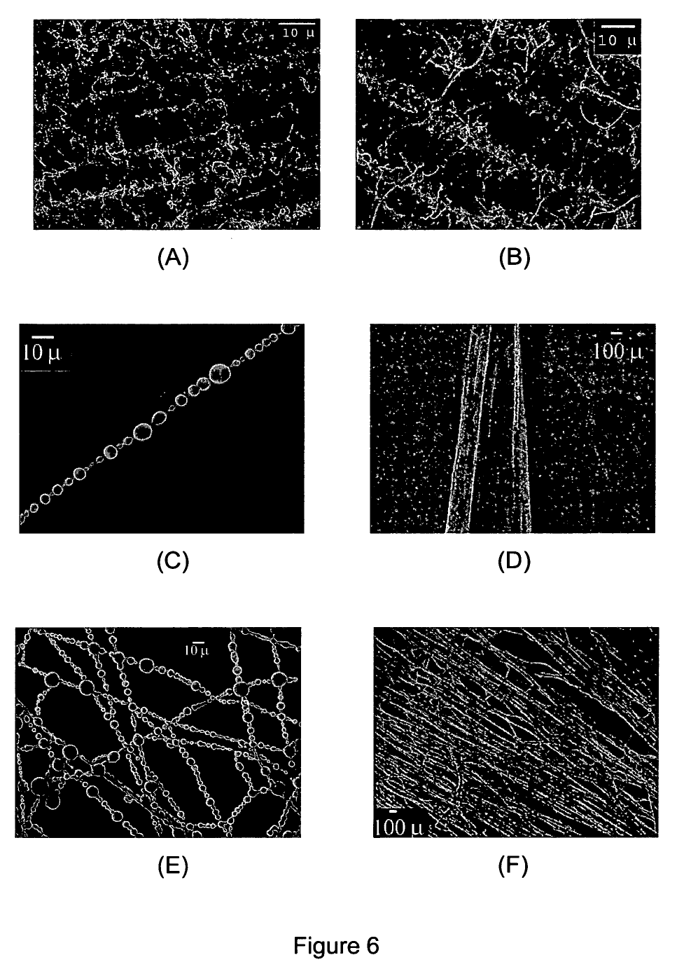

FIGS. 6(A) through 6(F) are SEM photographs of: cyanoacrylate polymer beads (FIGS. 6(C) and 6(E)) formed on the Nomex® fibers of FIG. 4 using the setup of FIG. 3(A); and cyanoacrylate polymer fibers (FIGS. 6(A), 6(B), 6(D) and 6(F)) formed on the Nomex® fibers of FIG. 4 using the setup of FIG. 3(A). Each Figure will be discussed in more detail below.

FIG. 6(A) is a SEM photograph of polycyanoacrylate fibers that are formed on nanofibers 60 of washer 50a at a source temperature of 240° C. for 1 hour using 50 milligrams of monomer starting material in the setup of FIG. 3(A).

FIG. 6(B) illustrates the effect additional water has on the fiber forming process. FIG. 6(B) is a SEM photograph of polycyanoacrylate fibers that are formed on nanofibers 60 of washer 50a at a source temperature of 240° C. for 1 hour using 50 milligrams of monomer starting material in the setup of FIG. 3(A). As can be seen from FIG. 6(B) the addition of liquid water to the setup of FIG. 3(A) increases the density of fibers formed.

FIG. 6(C) is a SEM photograph of polycyanoacrylate beads that are formed on nanofibers 60 of washer 50a at a source temperature of 290° C. for 1 hour using 50 milligrams of monomer starting material in the setup of FIG. 3(A).

FIG. 6(D) is a SEM photograph of polycyanoacrylate fibers that are formed on nanofibers 60 of washer 50a at a source temperature of 200° C. for 12 hours using 50 milligrams of monomer starting material in the setup of FIG. 3(A). As can be seen in FIG. 6(D), the fibers formed by the process of the present invention are noticeably larger.

FIG. 6(E) is a SEM photograph of polycyanoacrylate beads that are formed on nanofibers 60 of washer 50a at a source temperature of 300° C. for 1 hour using 100 milligrams of monomer starting material in the setup of FIG. 3(A).

FIG. 6(F) is a SEM photograph of polycyanoacrylate fibers that are formed on nanofibers 60 of washer 50a at a source temperature of 240° C. for 1 hour using 50 milligrams of monomer starting material and water in the setup of FIG. 3(A).

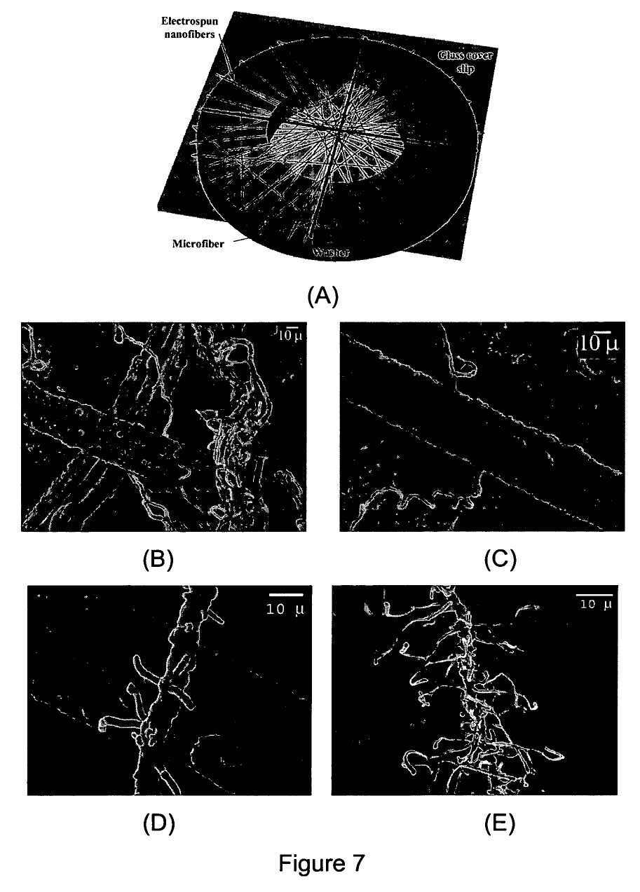

FIGS. 7(B) through 7(E) are SEM photographs of cyanoacrylate polymer fibers formed on the Nomex® fibers of FIG. 4 using the setup of FIG. 3(A) with the washer structure of FIG. 7(A). Each Figure will be discussed in more detail below.

FIG. 7(B) is a SEM photograph of polycyanoacrylate fibers formed on the Nomex® fibers formed on the washer structure of FIG. 7(A).

FIG. 7(C) is a SEM photograph of polycyanoacrylate fibers formed on the microfibers that make-up the microfiber cross of FIG. 7(A).

FIGS. 7(D) and 7(E) are SEM photographs of branched polycyanoacrylate fibers formed on the Nomex® fibers formed on the washer structure of FIG. 7(A).

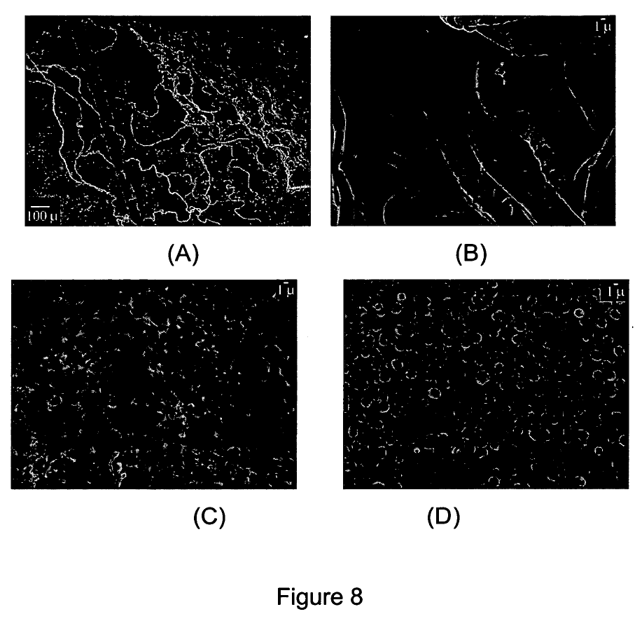

FIGS. 8(A) through 8(D) are SEM photographs of: cyanoacrylate polymer fibers formed on the Nomex® fibers (FIGS. 8(A) and 8(B)) of FIG. 4 using the setup of FIG. 3(A); cyanoacrylate polymer fibers formed on a glass substrate using the setup of FIG. 3(A) (FIG. 8(C)); and cyanoacrylate polymer beads formed on a glass substrate using the setup of FIG. 3(A) (FIG. 8(D)).

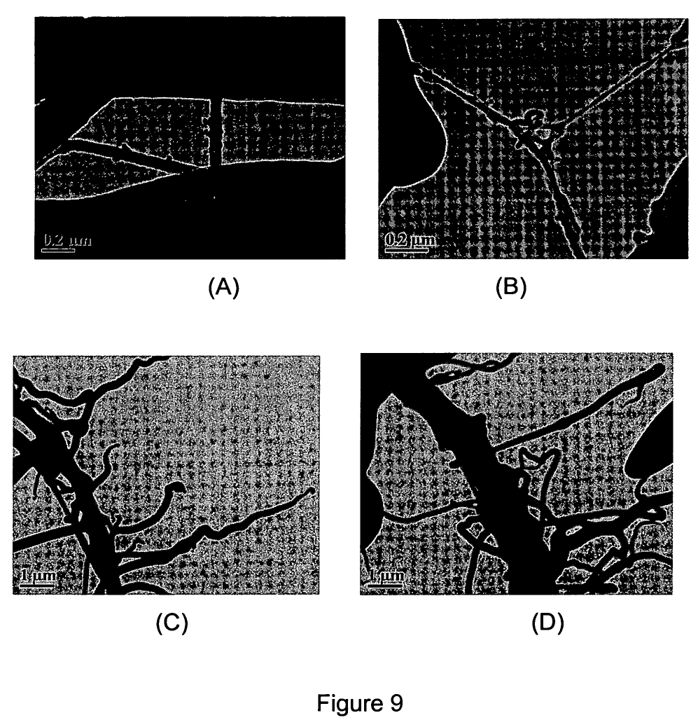

FIGS. 9(A) through 9(D) are tunneling electron microscope (TEM) photographs of cyanoacrylate polymer fibers formed on the Nomex® fibers of FIG. 4 using the setup of FIG. 3(A).

In FIGS. 9(A) and 9(B), the fibers shown are formed via the process described above on the Nomex® fibers of FIG. 4 using the setup of FIG. 3(A). The process is carried out using 50 milligrams of monomer starting material at a source temperature of 200° C. for 1 hour.

In FIGS. 9(C) and 9(D), the fibers shown are formed via the process described above on the Nomex® fibers of FIG. 4 using the setup of FIG. 3(A). The process is carried out using 50 milligrams of monomer starting material at a source temperature of 240° C. for 1 hour. Prior to polycyanoacrylate fiber formation, the Nomex® fibers are exposed to steam. As can be seen from FIGS. 9(C) and 9(D) less branching is observed in conjunction with an increase in the number of polycyanoacrylate fibers.

It should be noted that the present invention is not solely limited to the use of cyanoacrylate monomers. Other monomers can be employed and include, but are not limited to, any monomer that can undergo anionic polymerization of carbon-carbon double bonds. These include, but are not limited to, styrene monomers, methylmethacrylate monomers (MMA monomers), vinyl chloride monomers, diene-containing monomers. In another embodiment, the present invention can use an acrylate-containing monomer. For example, octyl cyanoacrylate can be anionically polymerized with water.

In still another embodiment, any condensation type of monomer can be used herein instead of, or in addition to, one or more cyanoacrylate monomers so long as such monomers undergo condensation polymerization, can be vaporized and/or sublimed, and can be captured by a suitable fiber and/or nanofiber substrate, web mat or membrane. Such monomers include, but are not limited to, ester monomers, carbonate monomers, amide monomers, urethane monomers, urea monomers, silicones, and organo-tins. In still another embodiment, free radical type of reactions using photoinitiators/initiators, that can be collected on the fiber and/or nanofiber substrate, web mat or membrane can be utilized (e.g., certain types of acrylate monomers or acrylonitrile-containing monomers).

In another embodiment, the present invention can utilize substrates, webs, mats and/or membranes formed from substances other than polymer fibers/nanofibers. Such substrates include, but are not limited to, microfibers (whether polymer or non-polymer), textile fibers, and hair.

The present invention can be used to form products for various uses, these include but are not limited to:
Polycyanoacrylate fibers can be used as a filter media. High surface area to mass for absorbing molecular substances such as HCl, H₂SO₄, NH₃, bases, and other such molecules. The polycyanoacrylate fibers and/or beads formed via the present invention can be used to coat or co-polymerize with an absorbing material. Also, these structures can be used to modify wire mesh screens.
Selective filters with hydrophilic or hydrophobic functional groups on the surface of the beads can be formed.
Formation of a surface treatment for wound dressing, filter media, enzymatic catalysis, sensors, and textiles.
The present invention enables one to control the porosity of filter media.
The present invention can be used to fabricate non-wetting surfaces by forming a layer of hydrophobic polymers fibers on a surface (i.e., mimic Lotus leaf effect or gecko feet effect).
The present invention can be used to surface treat large areas with free standing or entangled nanofibers. Both non-wetting and wetting embodiments can be formed depending on the monomer being used.
The present invention can be used to create biological and/or chemical sensors by using different functional groups in the termination step of anionic polymerization. The functional groups can capture analytes on their surface.
The present invention makes possible a method for attaching nanofibers together permanently at crossing points in a non-woven sheet or in a yarn or where a large drop contacts a nearby parallel fiber.
The present invention makes possible a method for attaching fibers to each other at short intervals to minimize nanofiber bending thereby making a stiffer structure with higher compressive strength.
The present invention makes possible a method for attaching nanofibers permanently to spatially periodic frames to create photonic devices.
The present invention makes possible a method for attaching nanofibers permanently to entrapped particles such as quantum dots, nanocrystals, bio-organelles.
The present invention makes possible a method for creating arrays of beads on fibers with the separation between beads being useful in photonic devices.
The present invention makes possible a method for creating structures to transport liquids, gases, or both. For example in fuel cell hydrogen and oxygen must be transported into the cell and water/water vapor must be removed.
The present invention makes possible a method for creating an open network of nanofibers that can hold a liquid by surface tension while the liquid is permitted to flow through the network by ‘wicking’. Particularly valuable for small portable fuel cells.
The present invention makes possible a method for creating improved bandages that remove or add fluids from wounds.
The present invention makes possible a method for creating shape recovery structures. Could be used in, for example, artificial bio-organs like dialysis tubes.
The present invention makes possible a method for creating stable 3D structures that are open and rigid.
The present invention makes possible a method for creating polycyanoacrylate nanospheres that have wide application in drug-delivery. Conventionally the nanospheres are coated with PEG or other polymer for targeted drug delivery. With the process disclosed herein functional groups can be obtained on the surface of nanospheres.
The present invention makes possible a method for creating polycyanoacrylate structures/nanostructures that have wide application as thermal and/or electrical insulators, since polycyanoacrylate is a good thermal and electrical insulator. In micro/nano-fabrication it can improve thermal and electrical properties of components it is exposed to because the volume resistivity of the monomer is about 8.6×10⁻¹⁰ ohm-cm.
Structures formed in accordance with the present invention can be employed as substitutes for, or supplements to, Gore-Tex polymer in raincoats, hiking boots, and the like, or as high strength textiles.
The structures of the present invention can be used to create membranes and filter media with controlled pore sizes.
The nanofiber structures of the present invention can be used as a template for coatings to make ceramic structures. For example, the structure would be coated by, for example, a sol gel coat precursor to make a titania structure. Other ceramic structures could be made by a similar process.
Another application is the use of nanostructures in accordance with the present invention to increase, significantly, the surface area of polymeric or natural fiber structures so that a greater quantity of a wax-like source of NO molecules can be held securely on the surface of the suture or other structure. The polycyanoacrylate nanostructures also provide interstices between the nanofibers and the surface of the suture that will hold useful quantities of wax, similarly to Vaseline applied to a hairy forearm holds quantities of the Vaseline between the hairs and the skin.

Although the invention has been described in detail with particular reference to certain embodiments detailed herein, other embodiments can achieve the same results. Variations and modifications of the present invention will be obvious to those skilled in the art and the present invention is intended to cover in the appended claims all such modifications and equivalents.

We claim:

1. A method for producing polymer nanostructures, the method comprising the steps of:
forming at least one nanostructure substrate, web, membrane or mat;
exposing the at least one nanostructure substrate, web, membrane or mat to at least one monomer composition, where the at least one monomer composition is in a vapor phase and the at least one monomer composition is deposited on the surface of and/or within the at least one nanostructure substrate, web, membrane or mat; and
subjecting the at least one exposed nanostructure substrate, web, membrane or mat to conditions suitable to polymerize the at least one monomer composition, thereby yielding polymer nanostructures where the polymer nanostructures are formed on and/or in the nanostructure substrate, web, membrane or mat.

2. The process of claim 1, wherein the at least one monomer composition is selected from one or more cyanoacrylate monomer.

3. The process of claim 2, wherein the one or more cyanoacrylate monomers contain at least one alkyl ester group.

4. The process of claim 3, wherein the one or more cyanoacrylate monomers are alkyl esters of 2-cyanoacrylic acid.

5. The process of claim 1, wherein the at least one monomer composition undergoes anionic polymerization.

6. The process of claim 5, wherein the at least one monomer composition contains at least one carbon-carbon double bond that enables the monomer composition to undergo anionic polymerization.

7. The process of claim 5, wherein the at least one monomer composition is selected from one or more cyanoacrylate monomers, styrene monomers, methylmethacrylate monomers, vinyl chloride monomers, diene-containing monomers, or combinations of two or more thereof.

8. The process of claim 1, wherein the at least one nanostructure substrate, web, membrane or mat is formed from a polymer composition, a ceramic compound, a metal or metal alloy, or a combination of two or more thereof.

9. The process of claim 1, wherein the at least one nanostructure substrate, web, membrane or mat is formed Nomex®.

10. A polymer nanostructure comprising:
at least one nanostructure substrate, web, membrane or mat; and
at least one polymer nanostructure formed on and/or in the at least one nanostructure substrate, web, membrane or mat.

11. The polymer nanostructure of claim 10, wherein the at least one polymer nanostructure is formed from one or more cyanoacrylate monomer.

12. The polymer nanostructure of claim 11, wherein the one or more cyanoacrylate monomers contain at least one alkyl ester group.

13. The polymer nanostructure of claim 12, wherein the one or more cyanoacrylate monomers are alkyl esters of 2-cyanoacrylic acid.

14. The polymer nanostructure of claim 10, wherein the at least one polymer nanostructure is formed from one or more monomer compositions that can undergo anionic polymerization.

15. The polymer nanostructure of claim 14, wherein the one or more monomer compositions contain at least one carbon-carbon double bond that enable the monomer compositions to undergo anionic polymerization.

16. The polymer nanostructure of claim 15, wherein the one or more monomer compositions are selected from one or more cyanoacrylate monomers, styrene monomers, methylmethacrylate monomers, vinyl chloride monomers, diene-containing monomer, or combinations of two or more thereof.

17. The polymer nanostructure of claim 10, wherein the at least one nanostructure substrate, web, membrane or mat is formed from a polymer composition, a ceramic compound, a metal or metal alloy, or a combination of two or more thereof.

18. The polymer nanostructure of claim 10, wherein the at least one nanostructure substrate, web, membrane or mat is formed Nomex®.
